(19) United States
(12) Patent Application Publication
(10) Pub. No.: US 2016/0070354 A1
(43) Pub. Date: Mar. 10, 2016

(54) Context-Aware Activation of Camera and Flashlight Modules

(71) Applicant: Google Technology Holdings LLC, Mountain View, CA (US)

(72) Inventors: Feng Liu, Sunnyvale, CA (US); Kevin Van Ngo, Sunnyvale, CA (US); Catherine T. Nguyen, Mountain View, CA (US); An Hoa Stearns, Santa Clara, CA (US)

(21) Appl. No.: 14/476,909

(22) Filed: Sep. 4, 2014

(51) Int. Cl. G06F 3/01; G06F 9/44; G06F 3/03

(52) U.S. Cl. CPC G06F 3/017; G06F 3/0304; G06F 9/44

(57) ABSTRACT

A system and method for gesture control of a mobile communications device link a single user gesture to a plurality of device functions or modules. One or more condition sensors associated with the device are then employed by the mobile communications device to disambiguate the gesture such that the device may then activate one of the plurality of device functions or modules. In this way, the user controls the activation of multiple functions or modules via use of a single gesture.

### TECHNICAL FIELD

The present disclosure is related generally to provision of a function on a mobile communications device and, more particularly, to a system and method for context-aware activation of camera and flashlight modules on the mobile communications device.

### BACKGROUND

As the capabilities of mobile communications devices expand, they inevitably encompass more and more everyday tasks that were previously accomplished by other devices. For example, a user of a mobile communications device may take spontaneous photographs of events as they unfold with a built in camera system and module. Similarly, a user finding themselves in a dark location and unable to see, can activate a flashlight module to light their surroundings.

However, in situations such as these wherein the user is either in a hurry or unable to see clearly, it can be difficult for the user to take all the necessary user input actions, e.g., button presses, key swipes, and so on, to activate the appropriate module, be it the camera module, flashlight module or another module

While providing for gesture activation of modules may present a partial solution to this dilemma, it introduces the secondary dilemma of forcing the user to memorize numerous distinct gestures to access numerous distinct modules. In particular, a gesture activation system such as this would assign a unique gesture to each module such that by making the appropriate gesture, the user activates the appropriate module.

The present disclosure is directed to a system that may eliminate some of the shortcomings noted in this Background section. However, it should be appreciated that any such benefit is not necessarily a limitation on the scope of the disclosed principles or of the attached claims, except to the extent expressly noted in the claims. Additionally, the discussion of technology in this Background section is merely reflective of inventor observations or considerations, and is not intended to be admitted or assumed prior art as to the discussed details. Moreover, the identification of the desirability of a certain course of action is the inventors' observation, and should not be assumed to be an art-recognized desirability.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a generalized schematic of an example device with respect to which the presently disclosed innovations may be implemented;

FIG. 2 is a module schematic of a device configured in accordance with embodiments of the disclosed principles;

FIG. 3 is a flow chart showing a process of context-based gesture disambiguation in accordance with embodiments of the disclosed principles; and

FIG. 4 is a flow chart showing a process of context-based gesture disambiguation in accordance with alternative embodiments of the disclosed principles.

### DETAILED DESCRIPTION

Before presenting a detailed discussion of embodiments of the disclosed principles, an overview of certain embodiments is given to aid the reader in approaching

In various embodiments of the disclosed principles, a mobile communications device is equipped and configured to associate a single user gesture with a plurality of functions, modules, or applications, and to select a particular function, module, or application to activate based on device context. Thus for example, an ambient light level at the device is used in an embodiment to select between a flashlight module and a camera module, both being assigned to the same user gesture. Many other pairings or assignments of modules to a single gesture are possible as well, and will be apparent based on the disclosure.

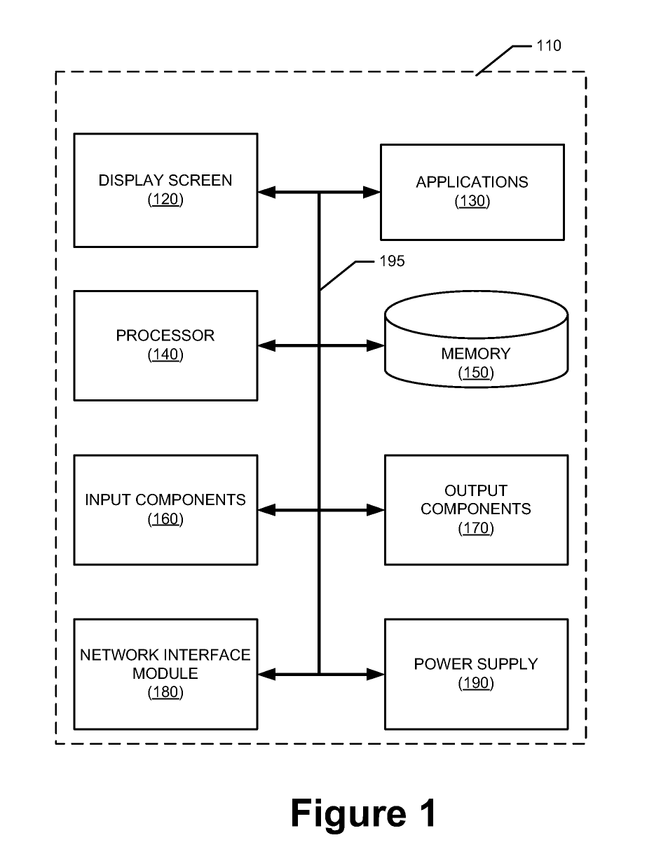

Turning now to a more detailed discussion in conjunction with the attached figures, techniques of the present disclosure are illustrated as being implemented in a suitable environment. The following description is based on embodiments of the disclosed principles and should not be taken as limiting the claims with regard to alternative embodiments that are not explicitly described herein. Thus, for example, while FIG. 1 illustrates an example mobile device within which embodiments of the disclosed principles may be implemented, it will be appreciated that many other types of portable device such as but not limited to tablet computers, hand-held gaming computers and so on may also be used.

The schematic diagram of FIG. 1 shows an exemplary device 110 forming part of an environment within which aspects of the present disclosure may be implemented. In particular, the schematic diagram illustrates a user device 110 including several exemplary components. It will be appreciated that additional or alternative components may be used in a given implementation depending upon user preference, cost, and other considerations.

In the illustrated embodiment, the components of the user device 110 include a display screen 120, applications 130, a processor 140, a memory 150, one or more input components 160 such as speech and text input facilities, and one or more output components 170 such as text and audible output facilities, e.g., one or more speakers.

The one or more input components 160 of the device 100 also include at least one sensor or system that measures or monitors the conditions of a current location of the device 100. The environmental information may include, for example, ambient light level, ambient noise level, voice detection or differentiation, movement detection and differentiation, and so on. Similarly, the device 100 may also include a sensor configured for determining location of device such as a GPS module and associated circuitry and software.

The processor 140 can be any of a microprocessor, microcomputer, application-specific integrated circuit, or the like. For example, the processor 140 can be implemented by one or more microprocessors or controllers from any desired family or manufacturer. Similarly, the memory 150 may reside on the same integrated circuit as the processor 140. Additionally or alternatively, the memory 150 may be accessed via a network, e.g., via cloud-based storage. The memory 150 may include a random access memory (i.e., Synchronous Dynamic Random Access Memory (SDRAM), Dynamic Random Access Memory (DRAM), RAMBUS Dynamic Random Access Memory (RDRM) or any other type of random access memory device). Additionally or alternatively, the memory 150 may include a read only memory (i.e., a hard drive, flash memory or any other desired type of memory device).

The information that is stored by the memory 150 can include program code associated with one or more operating systems or applications as well as informational data, e.g., program parameters, process data, etc. The operating system and applications are typically implemented via executable instructions stored in a non-transitory computer readable medium (e.g., memory 150) to control basic functions of the electronic device 110. Such functions may include, for example, interaction among various internal components and storage and retrieval of applications and data to and from the memory 150.

The illustrated device 110 also includes a network interface module 180 to provide wireless communications to and from the device 110. The network interface module 180 may include multiple communications interfaces, e.g., for cellular, WiFi, broadband and other communications. A power supply 190, such as a battery, is included for providing power to the device 110 and its components. In an embodiment, all or some of the internal components communicate with one another by way of one or more shared or dedicated internal communication links 195, such as an internal bus.

Further with respect to the applications, these typically utilize the operating system to provide more specific functionality, such as file system service and handling of protected and unprotected data stored in the memory 150. Although many applications may govern standard or required functionality of the user device 110, in many cases applications govern optional or specialized functionality, which can be provided, in some cases, by third party vendors unrelated to the device manufacturer.

Finally, with respect to informational data, e.g., program parameters and process data, this non-executable information can be referenced, manipulated, or written by the operating system or an application. Such informational data can include, for example, data that are preprogrammed into the device during manufacture, data that are created by the device, or any of a variety of types of information that is uploaded to, downloaded from, or otherwise accessed at servers or other devices with which the device is in communication during its ongoing operation.

In various embodiments, the device 110 is programmed such that the processor 140 and memory 150 interact with the other components of the device 110 to perform a variety of functions. The processor 140 may include or implement various modules and execute programs for initiating different activities such as launching an application, transferring data, and toggling through various graphical user interface objects (e.g., toggling through various icons that are linked to executable applications).

As noted above in overview, a mobile communication device operating in accordance with an embodiment of the disclosed principles is equipped and configured to associate a predetermined user gesture with a plurality of functions, modules, or applications. The device, in accordance with the disclosed principles, then selects a particular function, module, or application to activate based on device context such as ambient light level. Thus for example, an ambient light level at the device may be detected and used to select between activating a flashlight module and activating a camera module, with a high ambient light level indicating that the camera module is to be activated and a low ambient light level indicating that the flashlight module is to be activated.

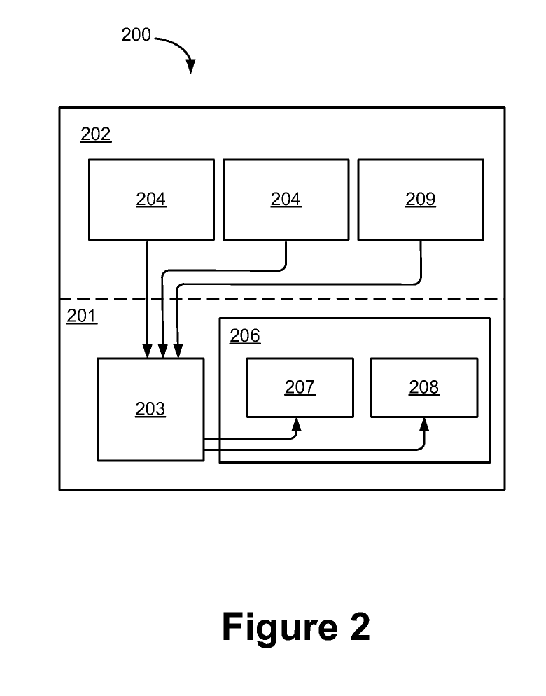

The simplified module-level architecture of FIG. 2 shows functions and modules usable to implement this example embodiment of the described principles. As can be seen, the example architecture 200 includes a number of hardware-implemented or processor-implemented functions or modules 201 and a number of system sensors 202. In particular a module activation function or module 203 (“activation module”) is linked to a system inertial sensor 204 or other type of movement sensor. In this way, the activation module 203 is able to collect data produced by the system inertial sensor 204 and to determine when the data indicates the performance of a user gesture.

Example gestures include but are not limited to repeated chop movements, swirling movements, or other movements that can be identified based on detecting the movement of the device. Appropriate gestures should be distinguishable from ordinary device movements that occur for example when the user is using the device. Thus, for example, the movement of simply turning the device over, while usable as a gesture in an implementation, would not typically be as distinguishable as a less common movement such as the double chop mentioned above.

The activation module 203 may also be linked to one or more other sensors such as an ambient light sensor 205. Thus, in an embodiment, the activation module 203 is able to determine an ambient light level via the ambient light sensor 205 when it detects via the inertial sensor 204 that the user has made an activation gesture. The activation module 203 may then command activation of a selected one of a group 206 of available modules/functions. The available modules/functions 206 in the illustrated example include a flashlight module 207 and a camera module 208.

It will be appreciated that the group 206 of available modules/functions may include additional or alternative modules/functions and that the system sensors 202 may include additional or alternative sensors 209. The sensors and modules used in a given implementation will depend upon the functions that the implementation is designed to pair and the condition (sound, light, location, speed when driving, connectivity, etc.) that the activation module 203 uses to choose among the functions.

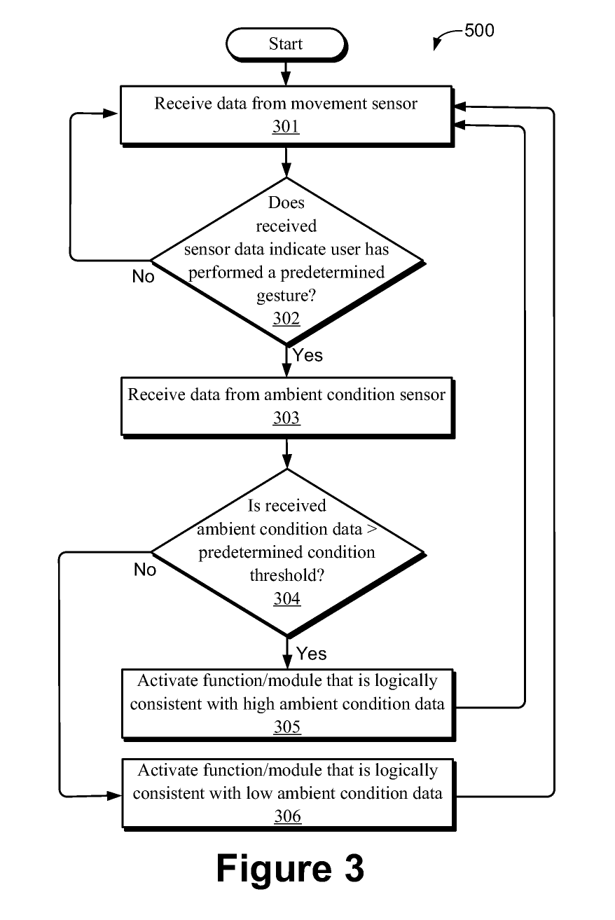

Although various processes may be used within the described principles to implement various examples, an example process 300 for gesture-based module activation is shown via the flowchart of FIG. 3. The example of FIG. 3 assumes an architecture resembling or similar to that shown in FIG. 2; however it will be appreciated that any suitable architecture may be used.

At the outset of the process 300, an activation module or the like samples or otherwise receives data from a movement sensor such as an inertial sensor or other movement sensor (stage 301). At stage 302, the activation module determines whether the received sensor data indicates that the user has performed a predetermined gesture. As noted above, the predetermined gesture may be a double chop motion or other gesture that can be differentiated from ordinary device motion in some way by the activation module.

If it is determined at stage 302 that the received sensor data indicates that the user has not performed the predetermined gesture, then the process 300 returns to stage 301, wherein the activation module again receives data from the movement sensor and continues from there. If instead it is determined at stage 302 that the received sensor data indicates that the user has performed the predetermined gesture, then the process 300 moves to stage 303.

At stage 303, the activation module samples or otherwise receives data from an ambient condition sensor such as an ambient light sensor. With the received ambient condition data, the activation module compares the received ambient condition data to a predetermined condition threshold at stage 304. For example, if the received ambient condition data is ambient light level data, the received data may be compared to a predetermined lumen threshold indicative of whether the user's (device's) surroundings exhibit a sufficiently low ambient light level to require use of a flashlight.

If it is determined at stage 304 that the received ambient condition data exceeds the predetermined condition threshold, then the process 300 flows to stage 305, wherein the activation module activates one of a plurality of available functions or modules that is logically consistent with the high ambient condition data. In the example above, wherein the ambient condition is ambient light level and the available modules are the camera module and the flashlight module, the high ambient light level would be consistent with use of the camera module and not the flashlight module. As such, stage 305 would entail the activation module activating the camera module.

If instead it is determined at stage 304 that the received ambient condition data is at or less than the predetermined condition threshold, then the process 300 flows to stage 306. The activation module activates one of the plurality of available functions or modules that is logically consistent with the low ambient condition data at stage 306. Continuing the example above (ambient condition is ambient light level and the available modules are the camera module and the flashlight module) the low ambient light level would be consistent with use of the flashlight module and not the camera module. As such, stage 306 would entail the activation module activating the flashlight module.

Thus, as can be seen in overview from the process 300, the user is able to turn on either the flashlight or the camera of the device using only a single gesture; the condition data disambiguates the gesture. As a result, it will be appreciated that the choice between modules for activation need not be binary. For example, two or more predetermined condition thresholds may be implemented to divide the sampled data space into three categories instead of simply above or below a single threshold. Alternatively or additionally, data from different ambient condition sensors may be used to further disambiguate a gesture that linked to three or more potential modules.

Thus, extending the above example for the sake of simplicity, the activation module may be configured to select among the camera module, the flashlight module, and a voice-to-text module. Moreover, the activation module may consider ambient condition data not just from the ambient light sensor but also from a GPS-based speed sensor usable to detect whether the user is driving. In this configuration, the voice-to-text module may be activated by the single predetermined gesture if the user is driving, regardless of the ambient light level. That is, of the three linked options (camera, flashlight and voice-to-text), only the voice-to-text module is consistent with the fact that the user is driving.

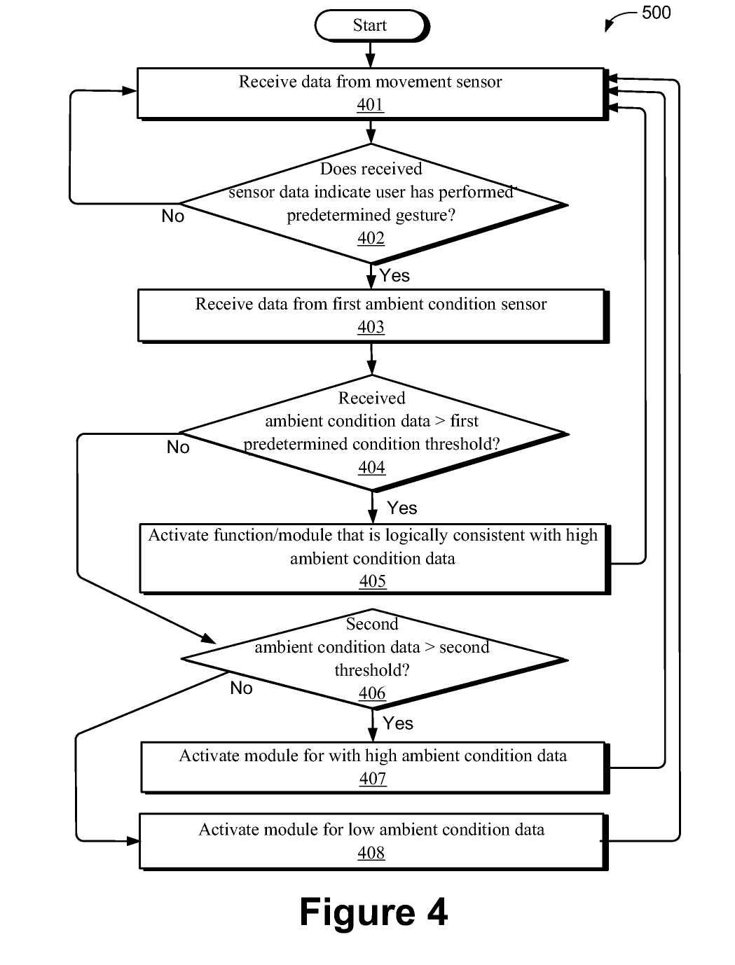

This principle is illustrated in greater detail using the above configuration as an example in the flowchart of FIG. 4. The illustrated process 400 begins at stage 401, wherein the activation module samples or otherwise receives data from the movement sensor (e.g., inertial sensor). The activation module determines whether the received sensor data indicates that the user has performed a predetermined gesture at stage 402. As noted above, the predetermined gesture may be any gesture that can be differentiated from ordinary device motion in some way by the activation module.

If it is determined at stage 402 that the user has not performed the predetermined gesture, then the process 400 returns to stage 401, wherein the activation module again receives data from the movement sensor and continues as indicated. If instead it is determined at stage 402 that the received sensor data indicates that the user has performed the predetermined gesture, then the process 400 moves to stage 403.

At stage 403, the activation module samples or otherwise receives data from a first ambient condition sensor such as the GPS-based speed sensor. With the received ambient condition data, the activation module compares the received ambient condition data (e.g., speed) to a first predetermined condition threshold (e.g., 5 mph) at stage 404. If it is determined at stage 404 that the ambient condition data is above the first predetermined condition threshold, then the process moves to stage 405, wherein the activation module activates the only one of the linked modules that is consistent with the received data (e.g., in the example, only the text-to-voice module is consistent with a driving user).

If instead at stage 404 it is determined that the ambient condition data (e.g., speed) is below the first predetermined condition threshold (e.g., 5 mph), then the process 400 moves to stage 406, wherein the activation module samples or otherwise receives data from a second ambient condition sensor (e.g., ambient light sensor). With the received ambient condition data from the second ambient condition sensor, the activation module compares the ambient condition (e.g., ambient light level) to a second predetermined condition threshold at stage 407.

From stage 407, if the received ambient condition data exceeds the predetermined condition threshold (e.g., ambient light level exceeds threshold), then the process flows to stage 408, wherein the activation module activates one of a plurality of available functions or modules that is logically consistent with the high ambient condition data, e.g., the camera module. If instead it is determined at stage 407 that the received ambient condition data is at or less than the second predetermined condition threshold, then the process flows to stage 409, wherein the activation module activates the one of the plurality of available functions or modules (e.g., flashlight module) that is logically consistent with the low ambient condition (e.g., low light) data.

Thus, in general, it will be appreciated that the disclosed principles allow a device user to use a single gesture to activate any one of a plurality of linked functions/modules through the use of ambient condition data to disambiguate the gesture. However, in view of the many possible embodiments to which the principles of the present disclosure may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. A method of activating a function on a mobile communications device having at least one motion sensor and at least one ambient condition sensor, the method comprising:
detecting a motion of the device using the at least one motion sensor;
determining that the detected motion matches a predetermined user gesture for function activation, the predetermined user gesture for function activation being linked to a plurality of device functions;
detecting at least one ambient condition via the at least one ambient condition sensor; and
selecting which of the plurality of device functions to activate based on the detected ambient condition.

2. The method in accordance with claim 1 wherein the at least one motion sensor includes an inertial sensor.

3. The method in accordance with claim 1 wherein the plurality of device functions include a camera function and a flashlight function.

4. The method in accordance with claim 3 wherein the at least one ambient condition sensor includes an ambient light sensor and wherein detecting at least one ambient condition further comprises detecting an ambient light level at the device.

5. The method in accordance with claim 4 wherein selecting which of the plurality of device functions to activate based on the detected ambient condition comprises selecting the camera function if the ambient light level at the device exceeds a predetermined threshold level, and otherwise activating the flashlight function.

6. The method in accordance with claim 5 wherein the predetermined user gesture for function activation includes a repeated chop motion of the device.

7. A method for gesture-activation of one of a plurality of functions on a mobile communications device comprising:
detecting motion of the mobile communications device indicative of performance of a user gesture linked to the plurality of functions;
detecting at least one ambient condition at the mobile communications device; and
identifying one of the plurality of functions for activation based on the detected at least one ambient condition; and
activating the identified function.

8. The method in accordance with claim 7 wherein detecting at least one ambient condition at the mobile communications device comprises detecting a first ambient condition and a second ambient condition.

9. The method in accordance with claim 8 wherein identifying one of the plurality of functions for activation based on the detected at least one ambient condition comprises selecting a first of the plurality of functions for activation if the first ambient condition indicates an ambient condition associated with the first of the plurality of functions.

10. The method in accordance with claim 9 wherein identifying one of the plurality of functions for activation based on the detected at least one ambient condition further comprises disregarding the first of the plurality of functions for activation if the first ambient condition indicates an value not associated with the first of the plurality of functions.

11. The method in accordance with claim 10 wherein identifying one of the plurality of functions for activation based on the detected at least one ambient condition further comprises selecting one of a second of the plurality of functions and a third of the plurality of functions for activation based on a second ambient condition.

12. The method in accordance with claim 9 wherein the first ambient condition is indicative of whether the user is driving a vehicle.

13. The method in accordance with claim 11 wherein the second of the plurality of functions is a camera function and the third of the plurality of functions is a flashlight function.

14. The method in accordance with claim 13 wherein the second ambient condition is an ambient light level at the device.

15. The method in accordance with claim 14 wherein selecting one of the second of the plurality of functions and the third of the plurality of functions for activation based on a second ambient condition comprises selecting the camera function for activation if the ambient light level at the device exceeds a predetermined threshold level, and otherwise selecting the flashlight function for activation.

16. The method in accordance with claim 15 wherein detecting a motion of the mobile communications device indicative of performance of a user gesture includes detecting a repeated chop motion of the device.

17. A mobile communications device for use by a user comprising:
a plurality of activatable device functions;
a motion sensor and at least one ambient condition sensor; and
a processor linked to the motion sensor and the at least one ambient condition sensor, the processor being configured to detect performance of a predetermined user gesture based on data from the motion sensor, the predetermined user gesture being associated with the plurality of activatable device functions, the processor being further configured to select one of the plurality of activatable device functions based on data from the at least one ambient condition sensor and to activate the selected function.

18. The mobile communications device in accordance with claim 17 wherein the plurality of activatable device functions comprise a camera function and a flashlight function.

19. The mobile communications device in accordance with claim 18 wherein the at least one ambient condition sensor includes an ambient light sensor and wherein the processor is configured to select one of the plurality of activatable device functions by activating the camera function if the ambient light level exceeds a predetermined threshold and otherwise to activate the flashlight module.

20. The mobile communications device in accordance with claim 17 wherein the at least one ambient condition sensor consists of two ambient condition sensors.
